(19) United States
(12) Patent Application Publication
(10) Pub. No.: US 2012/0111852 A1
(43) Pub. Date: May 10, 2012

(54) METHOD AND APPARATUS FOR TEMPERATURE MONITORING OF A COOK TOP

(75) Inventor: James Carter Bach, Seymour, IN (US)

(73) Assignee: GENERAL ELECTRIC COMPANY, Schenectady, NY (US)

(21) Appl. No.: 12/941,413

(22) Filed: Nov. 8, 2010

(51) Int. Cl. H05B 3/68

(52) U.S. Cl. 219/448.11

(57) ABSTRACT

A method and apparatus for monitoring the temperature of a cook top is provided. Overhead sensors are used for temperature sensing of a heating element, cooking utensil, and/or food located on the cook top. The resulting temperature information is then communicated to the cook top. Features associated with use of the temperature information such as various notifications to the operator and/or regulation of the heating elements can be also provided.

### FIELD OF THE INVENTION

The present invention relates to a method and apparatus for monitoring the temperature of a cook top and, more particularly, for sensing the temperature of a heating element, cooking utensil, and/or food located on the cook top.

### BACKGROUND OF THE INVENTION

Cook top appliances can include a variety of configurations for the heating elements located on the cook top surface. The number of heating elements or positions available for heating on the cook top can include e.g., four, six, or more depending upon the intended application and preferences of the buyer. These heating elements can vary in size and location along the surface of the cook top. Further, the types of heating elements available include, for example, gas burner, electric resistance (e.g., hot coil), electric radiant, and induction.

Cook tops have traditionally relied upon an operator to monitor temperatures during use. Attention to whether food is boiling, simmering, or otherwise at a certain temperature and/or for a certain period of time can be important for determining whether proper cooking has occurred. Uniformity of temperature throughout food during cooking can be important in determining that e.g., whether scorching or proper cooking is occurring. Temperature monitoring is also needed to ensure cooking oils or other substances do not reach an unsafe temperature. Similarly, certain utensils and cook top surfaces may require protection from higher temperatures.

Indoor cook tops are typically used with a ventilation system such as a range hood positioned over the cook top. A fan within the range hood is used to draw air across the cook top surface and remove heat and smoke to the outside. While manufacturers may supply a range hood and cook top in combination, frequently such products are offered as separate items having features that operate independently of each other. Such independence provides variety by allowing consumers to select such products separately based on individual needs and preferences. However, features that require communication between the range hood and cook top may be unavailable or limited when not provided together.

Accordingly, a method and apparatus for detecting temperatures on the surface of a variety of cook tops would be useful. More specifically, a method and apparatus for detecting the temperature of a heating element, utensil, and/or food on a variety of cook top configurations is needed. The ability to provide notifications of temperature conditions to a user of the cook top would also be very useful. Such a method or apparatus that can operate with a variety of different cook tops and range hoods would provide additional benefits.

### BRIEF DESCRIPTION OF THE INVENTION

Aspects and advantages of the invention will be set forth in part in the following description, or may be obvious from the description, or may be learned through practice of the invention.

In one exemplary embodiment, the present invention includes a temperature monitoring system for a cook top. The cook top includes a heating element. The system includes a temperature sensor positioned above the cook top and is configured for detecting the temperature of the heating element of the cook top, a cooking utensil on the heating element, a food in the utensil on the cook top, or a combination thereof A processor is configured for receiving temperature measurements collected by the temperature sensors and, depending upon the temperature measurements, providing instructions to the cook top, a notification to a user of the cook top, or both.

In another exemplary aspect, a method for monitoring the temperature of a cook top is provided. The cook top has at least one heating element. This exemplary method includes the steps of sensing the temperature of the heating element of the cook top, a cooking utensil on the heating element, a food in the utensil, or a combination thereof; transmitting the temperature information to the cook top; and processing the temperature information to determine if a temperature adjustment, an operator notification, or both should be implemented.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic illustration of an exemplary embodiment of the present invention using an array of temperature sensors.

FIG. 2 is a schematic illustration of another exemplary embodiment of the present invention using a single temperature sensor.

FIG. 3 is a schematic illustration of another exemplary embodiment of the present invention using a wire or cable connection (i.e. a data link) between a cook top and a range hood.

FIG. 4 is a schematic illustration of another exemplary embodiment of the present invention using AC wiring to provide connection (i.e. a data link) between a cook top and a range hood.

FIG. 5 is a schematic illustration of another exemplary embodiment of the present invention using a wireless connection (i.e. a data link) between a cook top and a range hood.

### DETAILED DESCRIPTION OF THE INVENTION

The present invention provides a method and apparatus for monitoring the temperature of a cook top and, more particularly, for sensing the temperature of at least one heating element, cooking utensil, and/or food located on the cook top. The present invention can operate with a variety of cook top configurations. Using the temperature information provided to the cook top, additional features such as notifications to the operator regarding temperature conditions and control of the heating elements can also be provided. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

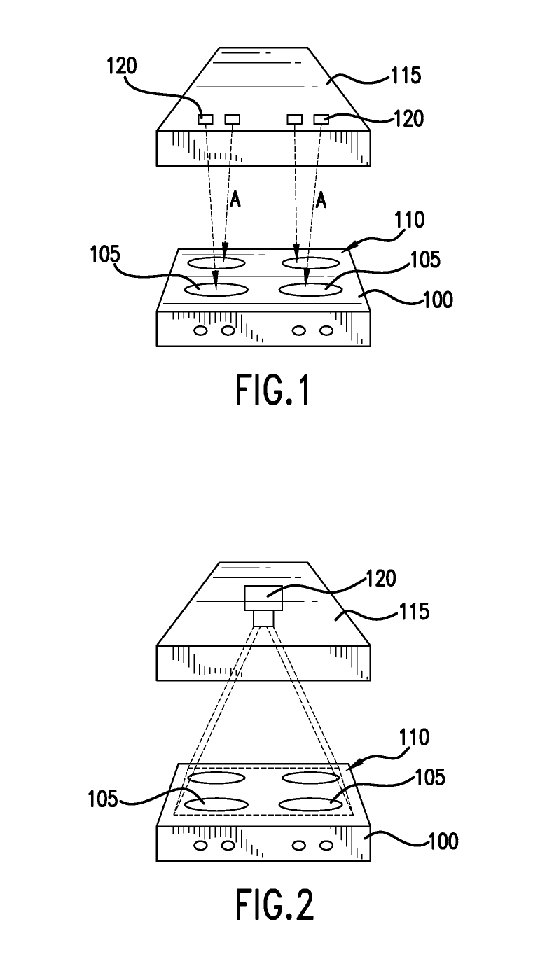

FIG. 1 provides a schematic illustration of an exemplary embodiment of a temperature monitoring system for a cook top 100. As shown, multiple heating elements 105 are positioned on the surface 110 of cook top 100. Heating elements 105 may be based upon, for example, gas burning, electric resistance (e.g., hot coil), electric radiant, and induction. While shown in FIG. 1 as being of equal size and positioned symmetrically about surface 110, it should be understood that the present invention may be used with heating elements of various sizes positioned as desired on cook top 100. Heating elements 105 may be configured for use with e.g., a pot or pan, or can be constructed as e.g., a grill or griddle. Heating elements 105 may be any shape (e.g. round, oval, square, rectangular, etc.).

A range hood 115 is positioned over cook top 100. Range hood 115 typically includes one or more ventilation fans to circulate air or remove heat and fumes. Hood 115 may also include one or more lights to illuminate surface 110 of cook top 100. Additional features such as filters or timers may also be included.

Range hood 115 also includes multiple temperature sensors 120. Temperature sensors 120 are positioned under range hood 115 and, for this exemplary embodiment, each sensor 120 is located approximately over a respective heating element 105. As illustrated using arrows A, each sensor 120 is also configured for detecting temperatures associated with a respective heating element 105 and providing such information to a processor configured with cook top 100 as further discussed below. By way of example, temperature sensor 120 may be constructed from an infrared (IR) sensor capable of “seeing” a particular location or an area on surface 110. More particularly, temperature sensor 120 may be configured to sense the temperature of e.g., a location on the surface of the heating element 105 such as a burner grate or an electric coil.

Because different models of cook tops have heating elements 105 located in varying positions on the cook top surface 110, temperature sensors 120 can be implemented mechanically such that, during installation of the range hood, sensor 120 can be aimed or directed e.g., towards the center of the heating elements 105. By way of example only, in one potential implementation, sensors 120 can be mounted similar to the readily positionable “eyeball lights” found in e.g., airplanes, automobiles, and home ceilings. In addition, range hood 115 can be equipped with more than four temperature sensors 120 (e.g., 6 or 8) so that hood 115 can accommodate a cook top 100 have more than four heating elements 105. To the extent any sensors 120 are not needed, such could be disabled during installation by e.g., a variety of means including, but not limited to, an “Enable/Disable” switch or button, an IR-blocking lens cover, removal of the sensor, or any combination thereof.

Alternatively, temperature sensor 120 may be used to sense the temperature of a utensil (e.g., pot or pan) placed on the heating element or the temperature of food (including solids and/or liquids) located in the utensil. In the case of food, for example, temperature sensor 120 may be focused on a particular portion of food such as e.g., the center of a portion of food placed on heating element 105 or may include a large area of food surface such that temperature information across such area is provided rather than the temperature at a particular point.

For example, in one exemplary embodiment of the invention, temperature sensors 120 can be adjustable so that the coverage area can be varied from e.g., a small spot at the center of the heating element 105 to a large spot that encompasses the entire heating element 105. Similar to a camera “zoom lens”, one exemplary embodiment could be a “zoom ring” around the lens of the sensor 120, wherein twisting/turning/pulling-on the ring would adjust the field of view of the sensor 120. In an alternative implementation, this adjustment of field of view could be made by motorized means (a motor driven lens) wherein the zoom-in/zoom-out control is provided by means of a knob or buttons on the control panel of the range hood.

In still another alternative, temperature sensor 120 may be used to sense temperature(s) associated with an area on cook top 100 rather than a particular point. For example, temperature sensor 120 can be configured to sense or scan the temperature of all, or substantially all, of the exposed surface of food being cooked on one of the heating elements 105. The resulting scan can be used to determine not only an average temperature but e.g., differences in temperature between food along the edges of a cooking utensil versus food along the center of the utensil. Such temperature information would be useful for determining whether the food is being properly cooked and/or uniformly heated to a desired temperature throughout the food.

FIG. 2 provides another exemplary embodiment of the present invention in which range hood 115 is provided with a single temperature sensor 120. For example, temperature sensor 120 may be constructed from an infrared sensor that scans the entire surface 110 of cook top 100 and provides temperature information to a processor configured with cook top 100. Such an IR sensor is similar to a video image sensor (e.g. CCD, etc.), wherein a large number of picture elements (pixels), arranged in a grid, provide temperature information at a large number of locations across the cook top surface 110. Accordingly, temperature information across the entire surface 110 is collected and can be evaluated by the processor. Thus, the exemplary embodiment of FIG. 2 allows range hood 115 to be provided with a variety of different configurations for cook top 100 including, for example, heating elements of different quantities, sizes, shapes, and locations about surface 110.

As stated, a processor, such as a microprocessor, electronic module, or other electronic control, can be used to evaluate the temperature information collected by one or more temperature sensors 120. Preferably, the processor is positioned within or otherwise associated with cook top 100. As such, the processor may be hidden from view of the operator and protected within an enclosure of cook top 100 located, for example, under surface 110. Other locations for the processor may be used as well. For example, the processor could be located in the range hood, cook top, or in a location separate from the range hood and/or cook top. Multiple processors may be used to perform different steps as well—such as e.g., one processor for treating the information received from sensors 120 and another processor for providing instructions to the cook top based upon the temperature information.

The processor can be provided with a variety of features to enhance the functionality of cook top 100. For the exemplary embodiment of FIG. 1, the processor can be programmed to provide the user with temperature information specific to each heating element 105. For example, a display, alarm, or other visual and/or aural features in communication with the processor can be included with cook top 100. Accordingly, the processor can provide temperature information to an operator including actual temperature readings and/or notifications based on the temperature information. Such notifications may include, for example, warnings that the temperature is too high or inappropriate for a heating element 105 of cook top 100, a utensil located on cook top 100, or a food on the utensil (such as a cooking oil about to overheat).

Notifications from the processor may also relate to important cooking information such as a signal that boiling has occurred, the length of time boiling has been detected, how long a particular temperature has been detected, current temperature readings, average temperature readings over time, and/or average temperature readings for an area such as the entire surface of a heating element 105 rather than a particular point.

The processor may also be provided with automatic shut-off functions for cook top 100. For example, in the event temperature sensors 120 detect a heating element 105 becoming too hot or a food such as cooking oil approaching a dangerous temperature, the processor could be configured to turn off the entire cook top 100 or a particular heating element 105. Alternatively, the processor may be configured to reduce temperature by adjusting a heating element 105 once a certain temperature has been detected. Such a feature might be useful, for example, in reducing the temperature at a heating element 105 once a food was sensed as reaching a boiling temperature. The processor might also be configured to turn off one or more heating elements 105 (and/or provide a warning) after a predetermined period of time e.g., 3 hours, of operation. Such might be useful where, for example, the user has unintentionally left on a heating element. These and other features may be provided as well.

By way of further example, with the embodiment of FIG. 2, the processor would be equipped to process the temperature information provided by sensor 120 in order to determine the location of heating elements 105 and temperature information associated therewith. Average temperatures across an area or temperatures associated with a particular location on surface 110 of cook top 100 may be determined by the processor using temperature information from sensor 120. In addition, the processor for the embodiment of FIG. 2 could also be provided with features similar to those set forth above with regard to the exemplary embodiment of FIG. 1.

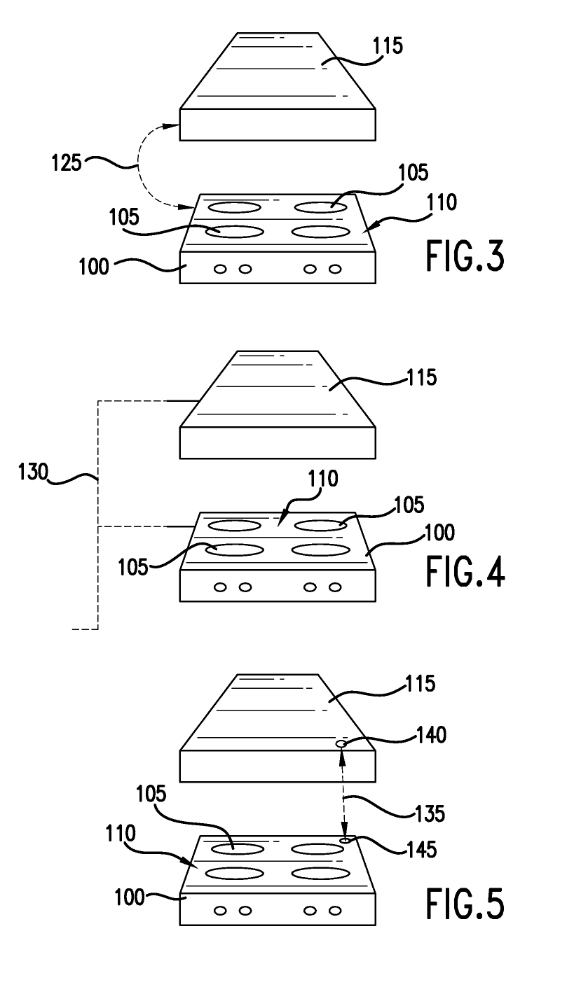

Communication between temperature sensor(s) 120 of range hood 115 and the processor associated with cook top 100 can be implemented with a variety of techniques. For example, FIG. 3 schematically illustrates a data link connection by a wire or cable 125 providing a dedicated point-to-point connection for the flow of information between a processor in cook top 100 and a processor in range hood 115. Preferably, cable 125 would be hidden behind a panel or included in a wall cavity during construction. Data can be transferred by any number of possible digital communication protocols including, but not limited to, RS-232, USB, Firewire, CAN, LIN, Ethernet, and others.

Temperature data can also be transferred by analog means, for instance, by a cable consisting of a plurality of wires, with each wire indicating the temperature of a specific heating element, with the voltage of the wire representing the temperature of that heating element. For example, a range hood capable of monitoring six heating elements might have a cable with seven (or more) wires, with one wire being a ground reference and six wires conveying the temperature by means of voltage. For instance, 0V might represent 0′F and 10V might represent 1000′F.

Alternatively, FIG. 4 illustrates another technique for connecting temperature sensor(s) 120 in range hood 115 and a processor in cook top 100. Here, AC electrical wiring 130 of the structure into which range hood 115 and cook top 100 are installed is used to as a provide a data link for communication of temperature information between temperature sensor(s) 120 and cook top 100. For example, the AC wiring can be used to transmit radio frequency signals carrying the temperature information. The actual transmission frequency and protocol used is unimportant, and could include any variety of custom or standard protocols, such as X10, FSK, NRZ, OOK etc.

In still another alternative, the exemplary embodiment of FIG. 5 uses a wireless data link 135 to provide communication between temperature sensor(s) 120 and a processor in cook top 100. Transceivers 140 and 145 located in range hood 115 and cook top 100 establish data link 135 between the appliances. As such, the use of a dedicated cable or wiring for the data link is eliminated. Based on the close proximity of cook top 100 and range hood 115, transceivers 140 and 145 could communicate effectively with relatively low power. Data can be transferred by a number of possible protocols includes, but not limited to, WiFi, ZigBee, BlueTooth and others.

In order to allow cook top 100 to be used with a variety of different range hoods 115, the processor can be configured to detect and identify the particular type and/or model of range hood 115 in use. For example, at the time cook top 100 and range hood 115 are installed, either in an original installation or remodel, the processor can configured to identify range hood 115 and thereby determine e.g., its positioning of temperature sensor(s) 120 as well as other features that might be available. As such, cook top 100 could be configured to operate with a variety of different types of range hoods 115 such that the consumer has a larger selection of appliance choices. In a similar manner, if the processor is provided with the range hood 115 or otherwise associated with temperature sensor(s) 120 positioned over cook top 100, then the processor could be configured to sense or otherwise determine what model or type of cook top 100 is being used below temperature sensor(s) 120.

Preferably, one or more temperature sensors 120 are located in a range hood 115 that is positioned over cook top 100. However, rather than an overhead range hood 115, some installations may use a ventilation system located adjacent to the cook top surface 110 to pull fumes and air down and then to the exterior. As such, temperature sensors 120 may be positioned over cook top 100 by other means such as an overhead shelf or a ceiling installation—and are not required to be positioned in a range hood. A data link 125, 130, or 135 connecting sensors 120 and a processor in cook top 100 can also be provided as previously described regardless of whether sensors 105 are located in a range hood.

The embodiments described above with reference to FIGS. 1-5 describe communication between one or more temperature sensors 120 positioned over the cook top surface 110 with a processor located e.g., in the cook top 100. However, other configurations are within the spirit and scope of the present invention.

For example, a processor could be positioned in a range hood 115 or other position over the cook top surface 110. The processor would receive temperature measurements from one or more sensors 120 and then communicate instructions, via a data link, to the cook top 100.

Alternatively, the processor could be positioned separate from the temperature sensors and the cook top. In such case, a first data link would provide temperature information to the processor and a second data link would provide for the transmission of instructions from the processor to the cook top.

In still another alternative, a first processor could be positioned in the range hood 115 or a position other than the cook top 100 and configured to receive temperature measurements from one or more sensors 120. This first processor could then provide temperature information, via e.g., a data link, to a second processor that in turn provides instructions to the cook top 100 including heating elements 105. This embodiment might be useful, for example, in the situation where a single temperature sensor 120 is position over the cook top as shown in FIG. 2. As such, the first processor might be configured to read the temperature measurements or scan that is provided by a single temperature sensor 120 and convert such into temperature information about the different heating elements 105 present on cook top 100. This information would then be communicated by a e.g., data link for subsequent action by the second processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A temperature monitoring system for a cook top, the cook top having at least one heating element, the system comprising:
a temperature sensor positioned above the cook top and configured for detecting the temperature of the heating element of the cook top, a cooking utensil on the heating element, a food in the utensil on the cook top, or a combination thereof; and
a processor configured for receiving temperature measurements collected by said temperature sensors and, depending upon the temperature measurements, providing instructions to the cook top, a notification to a user of the cook top, or both.

2. A temperature monitoring system for a cook top as in claim 1, wherein the cook top includes multiple heating elements, and wherein said temperature sensor comprises a plurality of temperature sensors with each associated to a respective heating element.

3. A temperature monitoring system for a cook top as in claim 1, wherein the cook top includes multiple heating elements, and wherein said temperature sensor is configured for providing temperature measurements associated with each of the heating elements.

4. A temperature monitoring system for a cook top as in claim 1, further comprising a warning or notification device in communication with said processor, and wherein said processor is configured to selectively activate said warning or notification device depending upon the temperature information received from said temperature sensor.

5. A temperature monitoring system for a cook top as in claim 1, wherein said processor is configured to reduce temperature or turn off the heating element depending upon the temperature information received from said temperature sensor.

6. A temperature monitoring system for a cook top as in claim 1, wherein said processor is configured to adjust the heating element depending upon the temperature information received from said temperature sensor.

7. A temperature monitoring system for a cook top as in claim 1, further comprising a data link for communicating temperature information collected by said temperature sensors to said processor.

8. A temperature monitoring system for a cook top as in claim 7, wherein said data link comprises a wireless connection between said temperature sensor and said processor.

9. A temperature monitoring system for a cook top as in claim 7, wherein said data link comprises a wired connection between said temperature sensor and said processor.

10. A temperature monitoring system for a cook top as in claim 7, wherein said data link comprises AC wiring carrying a radio-frequency signal from said temperature sensor to said processor.

11. A temperature monitoring system for a cook top as in claim 1, further comprising a data link for communicating instructions from said processor to the cook top.

12. A temperature monitoring system for a cook top as in claim 1, further comprising a range hood positioned over the cook top, and wherein said temperature sensor comprises an infrared sensor located in said range hood.

13. A method for monitoring the temperature of a cook top, the cook top having at least one heating element, the method comprising the steps of:
sensing the temperature of the heating element of the cook top, a cooking utensil on the heating element, a food in the utensil, or a combination thereof;
transmitting the temperature information to the cook top; and
processing the temperature information to determine if a temperature adjustment, an operator notification, or both should be implemented.

14. A method for monitoring the temperature of a cook top as in claim 13, wherein the method further comprises the step of determining whether a range hood is positioned over the cook top.

15. A method for monitoring the temperature of a cook top as in claim 13, wherein said step of sensing comprises sensing the temperature of the food in the utensil at multiple locations.

16. A method for monitoring the temperature of a cook top as in claim 15, further comprising the step of adjusting the temperature of the heating element based upon the temperature information from said step of sensing.

17. A method for monitoring the temperature of a cook top as in claim 16, wherein said step of adjusting comprises shutting off the heating element.

18. A method for monitoring the temperature of a cook top as in claim 13, further comprising the step of providing a notification to the operator of the cook top of a condition on the cook top based on the temperature information from said step of sensing.

19. A method for monitoring the temperature of a cook top as in claim 18, wherein the notification to the operator of the cook top comprises a message indicating that boiling is occurring on the cook top or a dangerous condition has occurred on the cook top.

20. A method for monitoring the temperature of a cook top as in claim 13, further comprising the step of shutting off the heating element after a predetermined period of time, providing a warning to the user after a predetermined period of time, or both.
